(19) United States
(12) Patent Application Publication
(10) Pub. No.: US 2019/0287257 A1
(43) Pub. Date: Sep. 19, 2019

(54) METHOD AND SYSTEM FOR MEASURING THE DISTANCE TO REMOTE OBJECTS

(71) Applicant: OBSCHESTVO S OGRANICHENNOI OTVETSTVENNOSTYU "DISICON", Nizhny Novgorod (RU)

(72) Inventors: Ivan Sergeevich SHISHALOV, Nizhny Novgorod (RU); Andrey Viktorovich FILIMONOV, selo Kamenki (RU); Oleg Andreevich GROMAZIN, Nizhny Novgorod (RU)

(73) Assignee: OBSCHESTVO S OGRANICHENNOI OTVETSTVENNOSTYU "DISICON", Nizhny Novgorod (RU)

(21) Appl. No.: 16/302,126

(22) PCT Filed: May 15, 2017
(86) PCT No.: PCT/RU2017/050040

§ 371 Date: Nov. 16, 2018

(30) Foreign Application Priority Data
May 17, 2016 (RU) 2016119050

(51) Int. Cl. G06T 7/536; G01C 3/08; G06T 7/73; H04N 7/18; H04N 5/232

(52) U.S. Cl. CPC G06T 7/536; G01C 3/08; H04N 5/23203; H04N 7/183; G06T 7/73

(57) ABSTRACT

The present invention relates in general to the field of measuring technology, and more particularly to methods and systems for measuring the distance to remote objects, and can be used for determining the distance to a remote object when viewed from a viewing point situated at a given height. A method for measuring the distance to remote objects consists in determining at least one point on a remote object and at least one point on the horizon from a given viewing height; obtaining data about the azimuth of the remote object and the azimuth of the at least one point on the horizon and data about the local topography on the azimuth of the object and on the azimuth of the at least one point on the horizon; determining at least one difference in elevation between the at least one point on a remote object and the at least one point on the horizon; determining the elevation of the at least one point on the horizon on the basis of the data about the azimuth of the at least one point on the horizon, the local topography and the given observation height; determining the elevation of the remote object on the basis of the obtained data about the elevation of the at least one point on the horizon and the difference in elevation between the at least one point on a remote object and the at least one point on the horizon; and determining the distance to the remote object on the basis of the data about the elevation of the remote object, the local topography, the azimuth of the remote object and the given observation height. The technical result is that of increasing the accuracy with which the distance to remote objects is determined.

### TECHNOLOGY FIELD

This invention can generally be categorized as measurement technology, in particular with regard to methods and systems for measuring distance to remote objects, and can be used for determining the distance to a remote object, involving observation from a camera from an established height.

### TECHNOLOGY LEVEL

Currently, solutions have risen into distinction in the technology level that measure the distance to remote objects; however, all of them, as a rule, use distance measuring and incline measuring devices (RCP).

The method for the positioning of remote objects is known from the technology level using RCP, which features at least three distance-measuring units, located a certain distance away from each other as well as away from the object, but within the limits of the object's direct visibility. The distance-measuring units, including the distance-measuring pointer unit, point their RCP at the object and determine the distance to that object. Then, the magnitude of the distance measured is transmitted to the distance-measuring unit of the pointer which determines the object's coordinates based on the measurements of the distances and according to the angle values of its slope and latitude [1].

This method enhances the high precision of a remote object's positioning on account of the higher accuracy in measuring linear distances compared to the measurement of angle coordinates; however, it features its own share of flaws stemming from the fact that it calls for exact knowledge of the slope angle and significant errors may be omitted due to the lack of a criterion for the RCP ray hitting the object.

### SUMMARY OF THE INVENTION

This technological solution is designed to eliminate flaws characteristic of existing solutions.

The technological challenge with this technological solution is the determining the distance to remote objects while observing from a point located at a particular height.

The technological result of this solution is the increased accuracy of determining the distance to remote objects.

The given technological result is achieved thanks to the method in which distance is measured to remote objects involving at least a single point of a remote object as well as at least one single point on the horizon being determined from an established observation height; data are obtained on the observation azimuth of the remote object, the observation azimuth of at least one point on the horizon, in addition to data regarding the topography features along the observation azimuth of at least one remote object point and the observation azimuth of at least one point on the horizon; they determine at least one angle difference of a location between at least one remote object point and at least one point on the horizon; they define the angle of the observation location of at least one point on the horizon on the basis of the data on the observation azimuth of at least one point on the horizon, the topography features, and the given observation height; they determine the angle of the location of observation of the remote object based on data on the angle of the observation location of at least one point on the horizon and the angle difference of the location between at least one remote object point and at least one previously established point on the horizon; they determine the distance to a remote object on the basis of data on the angle of the observation location of the remote object, the topography features, the observation azimuth of the remote object, and the given observation height.

In certain variations of this technological solution's implementation, data on the topography features entail a map of the topography's altitudes.

In other variations of this technological solution's implementation, a video camera is used to determine the azimuth of the object and the horizon as well as the angle difference between a remote object point and a point on the horizon, featuring internal and external calibration.

Still other variations of this technological solution's implementation use a controllable PTZ camera to determine an object's azimuth, the horizon, and the angle difference of the location between the remote object point and the point on the horizon, which features internal and external calibration and is pointed at the remote object.

In some embodiments of this technological solution, when the camera is used, the object and horizon point are contained on the same image.

In some embodiments of this technological solution, the refraction of optimal rays in the atmosphere are taken into account in determining the angle of the horizon point location as well as in determining the distance to the object.

In some embodiments of this technological solution, the mathematical model of a camera obscura is used in obtaining the observation azimuth of the remote object.

In some embodiments of this technological solution, Vincenty's formula is used in defining the angle of the remote object observation location.

The indicated technological result is achieved by way of a system that measures the distance to remote objects, containing a video camera designed to be able to at least obtain a shot containing at least one remote object and a horizon, a processor, and memory for storing instructions performed using the processor, whereby the processor is designed to:

define at least one remote object point and at least one point on the horizon from a given observation height; obtain data on the observation azimuth of the remote object, the observation azimuth of at least one point on the horizon, and data on the topography features along the observation azimuth of the object and the observation azimuth of at least one point on the horizon; define at least one angle difference between at least one remote object point and at least one horizon point; define the angle of an observation location of at least one point on the horizon on the basis of data on the observation azimuth of at least one point on the horizon, the topography features, and an established observation height; define the angle of the observation location of a remote object based on data on the angle of the observation location according to the lowest point on the horizon and the angle difference between at least one remote object point and at least one point on the horizon, defined previously; define the distance to a remote object based on data on the angle of the observation location of the remote object, the topography features, the observation azimuth of the remote object, and an established observation height.

In other embodiments of this technological solution, the video camera is positioned by a remote-controlled PTZ camera.

In some embodiments of this technological solution, the processor is a central or graphic processor.

In some embodiments of this technological solution, the memory is an energy-dependent storage device or an energy-independent storage device.

### BRIEF DESCRIPTION OF DRAWINGS

The characteristics and benefits of this invention are shown in the detailed description of the invention and the provided drawings, including:

FIG. 1, which shows an example of an embodiment of the technological solution according to the method for distance measurement to remote objects;

FIG. 2, which entails an example of a variation of the technological solution's implementation in which the distance must be determined from a camera located at an established height (view from above);

FIG. 3, which shows the general type of shot that is captured from the camera when a remote object is observed, the distance to which is required to be determined;

FIG. 4, which shows a variation for determining the angle difference between a remote object point and a point on the horizon;

FIG. 5, which provides illustration for the horizon line for a specific azimuth;

FIG. 6, which shows an example of the implementation of the determined angle of an observation location of at least one point on the horizon on the basis of data on the observation azimuth of at least one point on the horizon, topography features, and a given observation height;

FIG. 7, which shows an example of the determination of a remote object location's angle based on data on the angle of an observation location for the lowest point on the horizon and the angle difference of the observation location of the horizon and the remote object;

FIG. 8, which shows an example of the implementation of the determination of the distance to an object if the angle of the observation location of the remote object is known;

FIG. 9, which shows an example of a variation of the technological solution's implementation according to the system for measuring distance to remote objects.

FIG. 10, which demonstrates achievement of the technological result.

### DETAILED DESCRIPTION OF THE INVENTION

This technological solution can be implemented in a computer in the form of a system or a machine-readable medium containing instructions for the method depicted above to be executed.

The technological solution can be implemented in the form of a distributed computer system.

Construed as a “system” for the purposes of this solution is a computer system, an ECM (electronic computing machine), SNC (software numeric control), a PLC (programmable logic controller), computerized control systems, and any devices capable of executing an established, distinctly defined operations sequence (of actions or instructions).

Construed as a “command processing device” is an electronic unit or integration scheme (microprocessor) executing machine instructions (software).

The command processing device counts and executes machine instructions (software) from one or more data storage devices. Media that may function as a data storage device include, but are not limited to, hard disk drives (HDD), flash memory, ROM (read-only memory), solid state drives (SSD), and optical drives.

A “program” is a sequence of instructions designed for execution by a computation machine management device or a device that processes commands.

Provided below are terms and concepts required to understand the means of this technological solution's implementation.

A remote object: is an object located a rather long distance away from the observation point.

A location angle (elevation): is the angular height of the object being observed (an object on the ground, an aircraft, a light in the sky, etc.) above the true horizon. The location angle along with the azimuth serve to define the direction toward an observed object. Observation from above the true horizon entails a positive angle of the location while observation from below entails a negative angle of the location.

A shot: is data obtained from the matrix and a set of points (pixels), each of which is attributed characteristics (brightness) or several characteristics (brightness, color components)

A pixel: is the smallest logical element of a two-dimensional digital image in a raster graphic, or an element in a matrix of displays creating an image, or an element of a camera matrix creating an image.

Camera calibration: is the task of achieving internal and external parameters in the camera based on the available photographs or videos that it captured. Camera calibration is often used on the initial stage of the solution of many computer vision tasks, especially in augmented reality.

A calibrated camera: is a mathematical model obtained as a result of calibration (described with the help of formulas or tables), connecting the points of an image (pixel) and the direction the optical ray is arriving in, displayed by this pixel, providing a means to compare objects on the image as well as their counterimage in three-dimensional space.

An azimuth: is the angle between a line pointing straight North and a line pointing to a given object or the current direction being analyzed.

The observation azimuth of a remote object: is an azimuth under which a specific remote object is observed. If remote objects feature large angular dimensions for the azimuth, the remote object azimuth can be considered to be the azimuth of the observed center of the object. In other words, it is an azimuth under which optical rays arrive from a remote object.

The observation azimuth of a horizon point: is the azimuth for which a specific horizon point is observed. In other words, it's an azimuth under which optical rays arrive from a specific point on the horizon.

The angle of the observation location of a remote object is the angle of a location under which the remote object is observed. Meanwhile, if the object features large angular dimensions for the location's angle, for this invention, the angle of the location of the object's lowest point will be taken to be the object's location.

The angle of the observation location point on the horizon: is the angle of the location of a specific point on the horizon with a specific azimuth.

An observation height: is the height over the surface of the land and a point with a known location from which observation is undertaken and/or the distances to an object is determined.

A direct visibility line: is a path of direct visibility (unblocked by the horizon) dissemination of radiowaves (including the optical diapason) without consideration of their refraction and effect on the Earth.

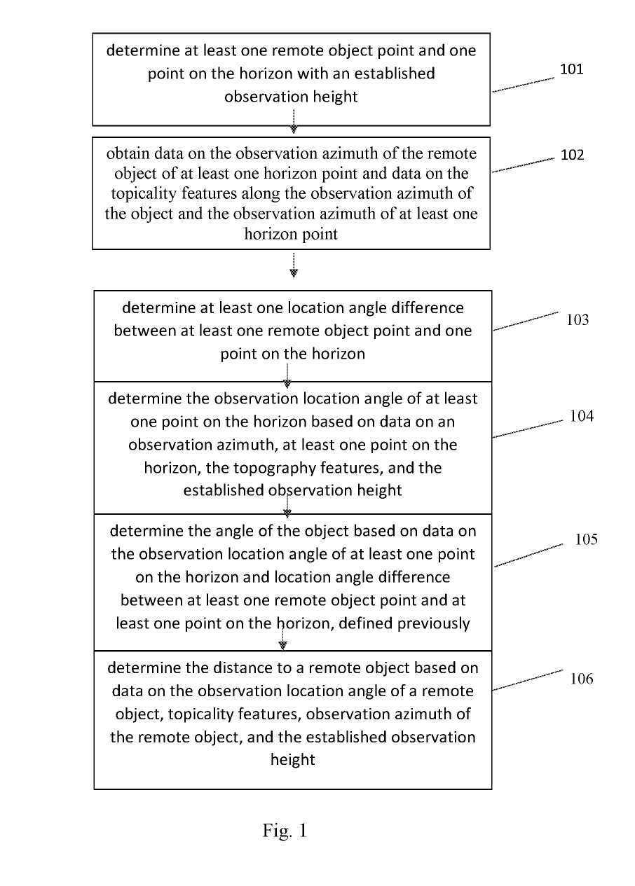

FIG. 1 shows a flow scheme that demonstrates the method in which the distance to the remote objects is measured, which contains the following steps:

Step 101: they define at least one remote object point and at least one horizon point with an established observation height.

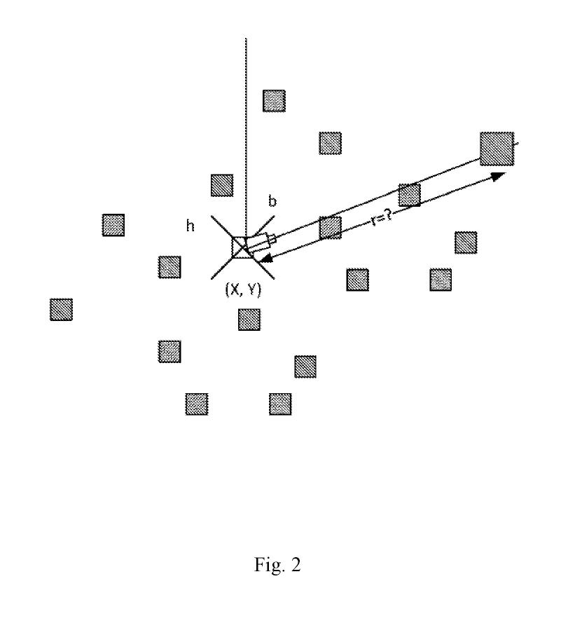

In some embodiments, one remote object point and at least one point on the horizon are defined based on a shot or a sequence of shots obtained from a camera, situated at known coordinates, at a specific, known height above the ground. A somewhat remote object is observed from the camera under a known azimuth (FIG. 2). The camera features known internal calibration, in other words—the relationship of the angle at which the optical ray arrives relative to the optical axis and the matrix plane. In some embodiments, this relationship may be demonstrated via calibrated characteristics, for instance information on the vertical and horizontal viewing angle of a camera and the resolution of the matrix along a vertical and horizontal line.

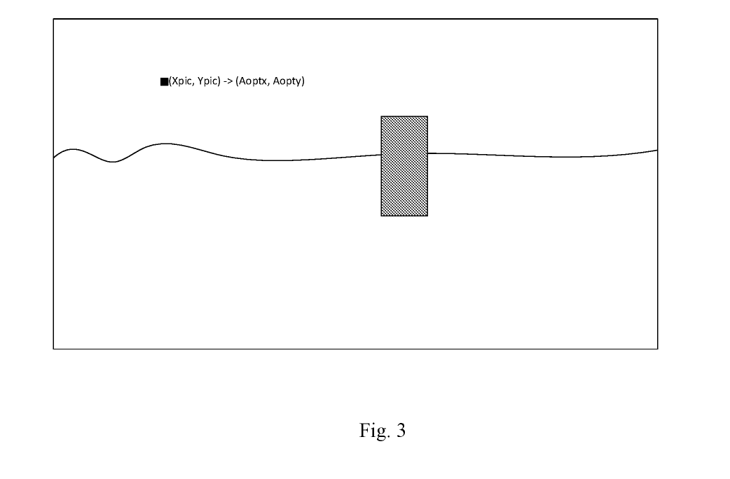

Shown in FIG. 3 is the general shot that is obtained from the camera when the remote object is observed, the distance to which is required to be determined.

The remote object (for instance, the lowest point of the object and the central point) and at least one horizon point can be established by the user with the help of the user interface (in one of the variations, these points can be found on a single azimuth, but this doesn't take away from the commonality at which these points can be found along different azimuths). In certain embodiments, the remote object is defined as well as at least one point on the horizon with a given observation height automatically using a computer viewing system (when the computer viewing system automatically finds points on the horizon and object, the distance to which must be measured).

In the case that a computer viewing system is used, a horizon search must be implemented using a horizontal line searching algorithm described in the source [2]; meanwhile, a search for the remote object of interest may be implemented with the help of algorithms for highlighting various objects, using a model of the object described in the source [2]. One of the following methods, not limited to the following, may be used to determine the edges of the contrast objects: a combinatorial method or a threshold gradient method, as well as a contour highlighting method by way of applying the Laplace operator and the Gaussian filter method, as well as a method that uses the Sobel operator.

Step 102: Data are obtained on the observation azimuth for at least one point of the remote object and observation azimuth, at least one horizon point, and data on the topicality features along the observation azimuth, at least one point of a remote object and an observation azimuth of at least one horizon point in the observation of a remote object, the distance to which is to be determined.

They determine the angle at which the optical rays arrive for determining the azimuth of the remote object's observation (the angle at which the optical rays arrive) relative to the optical axis of the camera (in the simplest case, the axis may coincide with the direction at which the central pixel of the shot arrives) and in the adopted calibrated characteristics model, the angle at which the ray is arriving can be determined via the viewing and resolution angles with the coordinates Xpic, ypic (the point coordinates of an image from the upper-right corner of the image) relative to the center of the shot.

For this purpose, the following approximated formula for instance may be used:

$$\begin{matrix}{A}_{optX} = ( {X}_{pic} - \frac{{X}_{max}}{2} ) \cdot \frac{{A}_{obzX}}{{X}_{max}} & ( 1 ) \\ {A}_{optY} = ( {Y}_{pic} - \frac{{Y}_{max}}{2} ) \cdot \frac{{A}_{obzY}}{{Y}_{max}} & ( 2 )\end{matrix}$$

where: Aₒₚₜₓ is the angle at which the optical ray arrives along a horizontal line relative to the center of the shot with the given pixel coordinates for the image; X_{pic} is the coordinate on the horizontal line of the pixel, the arrival angle of which is of no interest to us; and Xₘₐₓ is the shot resolution along a horizontal line; A_{obzX} is the viewing angle of a shot on a horizontal line; the horizontal line of the pixel the arrival angle of which is of not interest to us; Xₘₐₓ is the resolution of the shot on a horizontal line; A_{obtY} is the angle at which the optical ray arrives along a vertical line, relative to the center of the shot with the given coordinates of the pixel on the shot; Y_{pic} is the vertical coordinate of the arrival angel pixel, which is of no interest to us; Ymax is the vertical line shot resolution; and A_{obzY} is the viewing angle of the shot on a vertical line.

The formula expounded below is approximated but is sufficient to achieve the technological result desired. In other words, for greater accuracy in determining the distance to a remote object. However, for the purpose of improving angular calculation for the future, the mathematical angle of the camera obscura can be used, expounded, for instance, in sources [2] or [3], or more complex, calibrated camera characteristics with consideration of distortion and other features of optical devices. The primary aspect is determining the azimuth of the remote object's observation (the arrival angle of optical rays) and the comparison of these angels with the pixels of the image.

The azimuth of the direction of the optical axis of the camera is obtained from the camera's mechanism (the angel at which the camera turns along a horizontal line) before displacement angles are added to it relative to the optical axis, which provides a means to determine the observation azimuths of different points.

The topography features map of may be presented in the form of a database featuring the heights of points with their coordinates indicated, a so-called altitudes map. Such a database may feature, for instance, a regular structure featuring the heights of points above sea level for points with coordinates differing by a single angular second from each other. Then, various interpolation methods can be used to determine the height of a point between regular network points indicated in the base, for instance, the linear interpolation method showed in source [4].

Meanwhile, using formulas (1) and (2), the calibrated characteristics of the cameras (viewing and resolution angles) and the points indicated by the user, in other words pixels, having placed, instead of X_{pic} and Y_{pic}—

X_{pic1}, Y_{pic1}, and X_{pic2}, Y_{pic2} correspondingly, the arrival corners of the optical ray are determined of at least one horizon point and object observed along the horizontal line A_{optX1} points of the horizon, A_{optX2} object, and vertical line A_{optY1}, A_{optY2} relative to the optical axis of the camera and the shot's orientation.

Step 103: at least one angle difference of the location between at least one point of the remote object and at least one horizon point are determined as A_{optY1}-A_{optY2}.

Thus, they determine how much the object's observation angle differs from the angle of the horizon point's visibility, in other words—what the angle is between these two lines along the location's angle.

To calculate the angle difference along the vertical line in certain implementation variants, a formula is used that will provide an approximated evaluation of the angle difference between two rays on a vertical line:

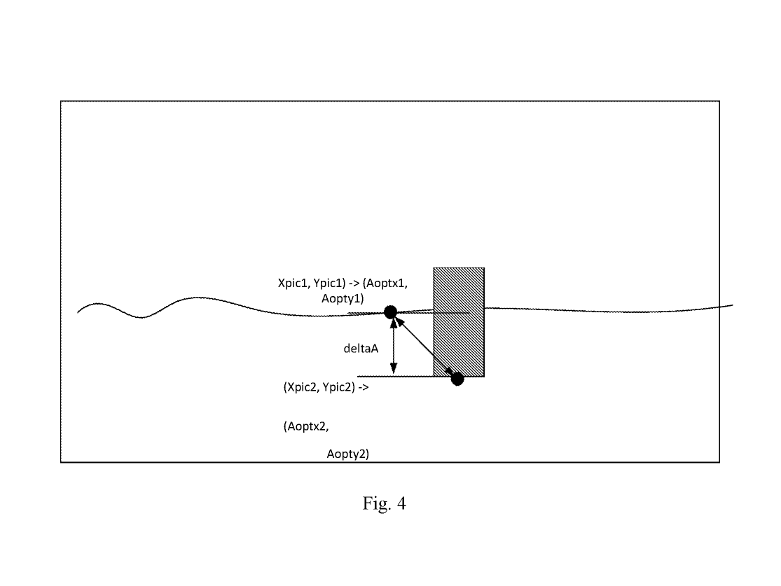

deltaA=A_{optY1}−A_{optY2} (3) (FIG. 4).

Step 104: they determine the angle of the observation location of at least one horizon point on the basis of data on the observation azimuth of at least one point on the horizon, topicality features, and an established observation height;

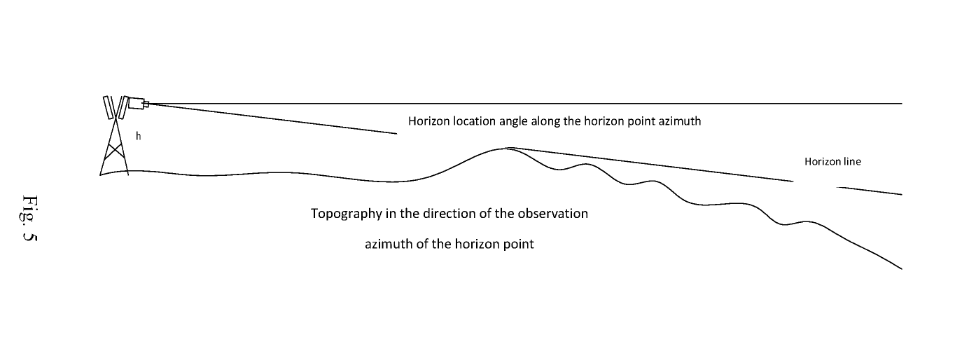

Using information on the camera location coordinates, the height of its installation, and its observation azimuth, the “horizon line” can be determined in this direction (azimuth) as well as its location angel (vertical angle), in other words a kind of line which you can see the ground below and the sky above. Illustration of the horizon line is shown in FIG. 5.

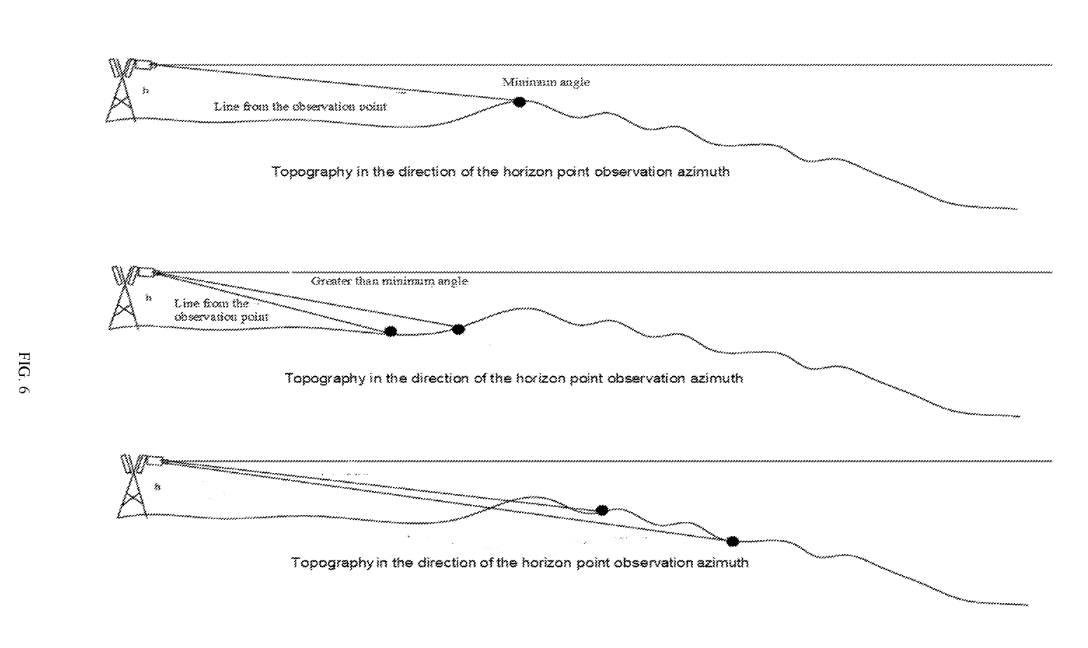

In some embodiments, the height of the observation point is determined which is why the elevation (of the camera) “h” is added to the height value from the heights map. Along the established azimuth, points are taken across equal spaces (a direct Vincenty's formula is used to find these points (information source [5]) as well as the method described in source [6]), the size of which is determined based on the required accuracy and the abilities of the heights map that permit it. For each point its height value is taken from the heights map (or if it doesn't coincide with the regular network in the heights map base, interpolation values), which is corrected in accordance with a model of the Earth's surface (for instance, in accordance with a spherical or geoidal model) and an angle of the location is calculated for it from the observation point. This angle is calculated for all the points along the established azimuth, all the way to the maximum established distance (which is selected based on empirical ideas on the possible remoteness of the horizon, for instance 200 km). The point with the maximum location angel and line on it is the horizon point; meanwhile, the location angel on it is the location horizon angle location (FIG. 6).

Step 105: they determine the angel of the observation location of the remote object based on data on the angle of the observation location of at least one horizon point and angular difference of the location between at least one remote object point and at least one horizon point, defined previously.

After the horizon line and the location angle of the horizon line are defined, the angel of the remote object's observation location is defined, counting down the deltaA angle from this angle—the angle difference of the horizon observation remote object location, defined previously.

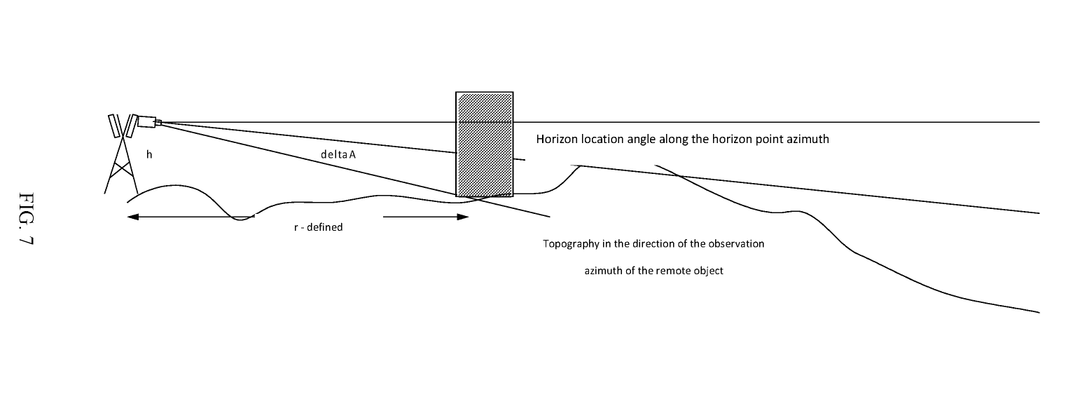

They determine the intersection point of the ray emitted from the camera's location point (at a height “h”) with the ground under the angle of the location calculated on the previous step (FIG. 7).

Step 106: they determine the distance to the remote object on the basis of data on the angle of the observation location of the remote object, topicality features, remote object observation azimuth, and the established observation height.

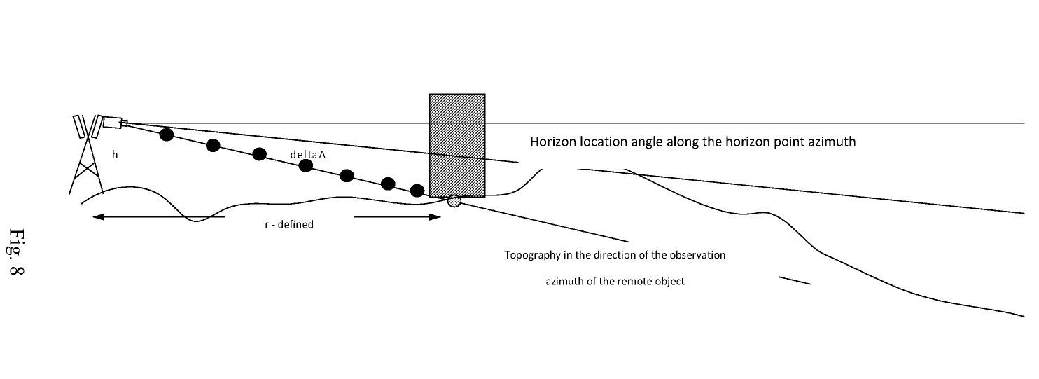

After obtaining the intersection point, they determine the distance to the object. To do so, in certain embodiments, the ray is traced out of the observation point along the established azimuth and obtained location angles. Points are selected on the ray with equal distance intervals (FIG. 8), determined based on the required accuracy (for instance, each 10 in) and they check whether this point is located below the ground level, obtained from the heights map and designed in accordance with the Earth model (for each point from the heights map, based on the model form of the Earth and the distance from the observer's position to that point; the displacement is calculated along the altitude, caused by the influence of the Earth model). In certain embodiments, the intervals may be unequal. The closest point on the ray to the observation location which turned out to be lower than the ground level is considered to be the intersection point of the ray and the ground. This point's coordinate is determined and the distance is calculated between the points of the camera's location (the coordinates are known) and this point, for instance, using the approximated distance formula for the sphere

L=R·arc cos(sin θ₁·sine θ₂+cos θ₁·cos θ₂·cos(ϕ₁−ϕ₂)).

In this case, θ₁ and θ₂ are called latitudes, while φ₁ and φ₂ are called longitudes, R is the Earth's radius, and L is the unknown distance to the object. Alternatively, a reverse Vincentyy formula can be used (information sources [5] and [6]).

In some embodiments, the length of the obtained section on the ray can be used, since the error at a low camera height (30-60 in) and with a faraway object (5 km or more) will not be significant.

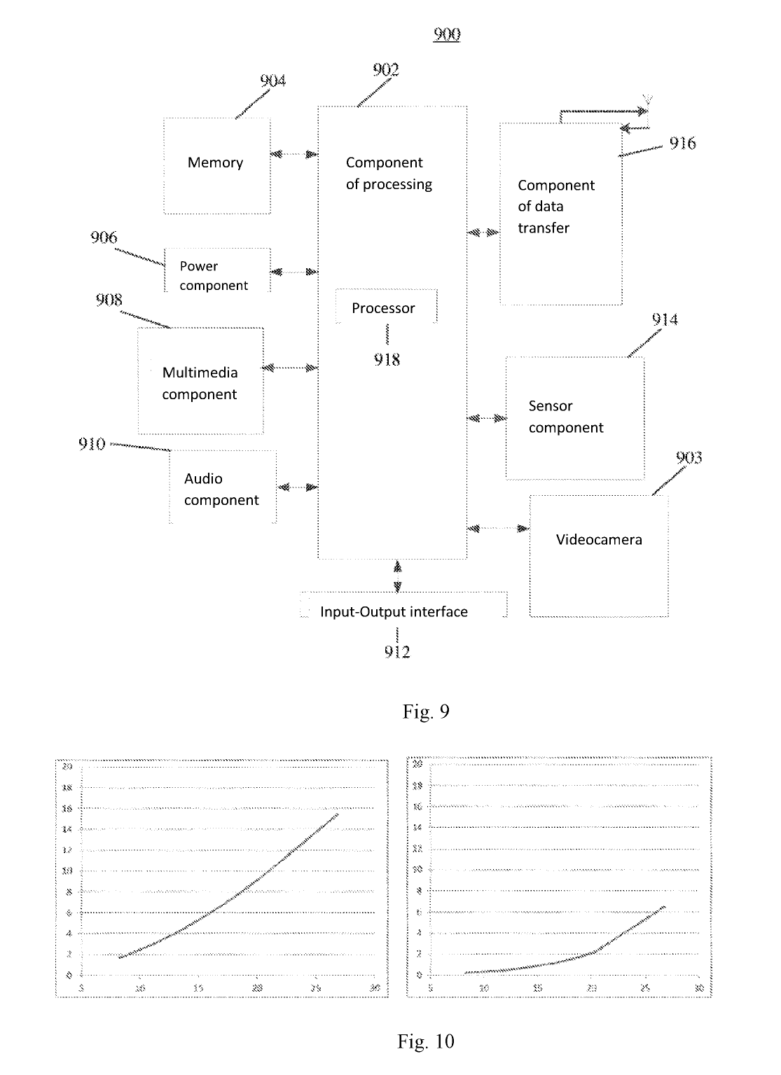

FIG. 9 entails a flow diagram showing the distance measurement system to remote objects according to the example of the invention's implementation.

The system includes a video camera designed to be able to obtain at least one shot containing at least one remote object and horizon;
a processor;
memory to store instructions which may be executed using the processor,

wherein the processor is configured to:

determine at least one remote object point and one horizon point with an established observation height;

obtain data on the observation azimuth of the remote object, the observation azimuth of at least one point on the horizon, and topicality features data for the object observation azimuth and the observation azimuth of at least one horizon point;
determine at least one location angle difference between at least one point of the remote object and at least one horizon point;

determine the angle of the observation location of at least one horizon point on the basis of azimuth observation data, and at least one horizon point, the topicality features, and the established observation height;

determine the observation location of a remote object based on data on the observation location angle of at least one horizon point and angle difference of the location between at least one remote object point and at least one horizon point, 5 determined previously;

determine the distance to a remote object on the basis of data on the observation angle location of the remote object and the established observation height.

In certain embodiments, a system 900 may be a cell phone, computer, messaging device, tablet, personal digital assistant, etc.

Referring to FIG. 9, a system 900 may include one or more of the following components: a processing component 902, video camera 903, memory unit 904, power component 906, multimedia component 908, input/output (I/O) interface 912, sensor component 914, or a data transfer component 916.

In some embodiments, the processing component 902 mostly controls all the operations of the system 900, for instance the display, data transmission, video camera operation, and recording operation. A processing component 902 may involve one or more processors 918 carrying out instructions for completing all or part of the steps of the methods indicated above. Furthermore, the processing component 902 may include one or more modules for convenient processing of interactions between a processing component 902 and other components. For instance, a processing component 902 may include a multimedia module for convenient facilitated interaction between the multimedia component 908 and processing component 902.

The memory unit 904 is designed to be able to store various types of data to support the operation system 900. Examples of such data include instructions from any application or method, Image, video, etc. The memory unit 904 may be implemented in the form of any type of energy-dependent storage device, energy-independent storage device, or a combination of them, for instance a Static Random-Access Memory (SRAM), Electrically Erasable Programmable Read-Only Memory (EEPROM), Erasable Programmable Random-Access Memory (EPRAM), Programmable Random-Access Memory (PRAM), Random-Access Memory (RAM), magnetic memory, flash memory, or a magnetic or optical disk.

In some embodiments, the power component 906 provides various components of the system 900 with power. The power component 906 may include a powering management system, one or more power sources, as well as other nodes for the generation, management, and distribution of power to the system 900.

In some embodiments, the multimedia component 908 includes a screen featuring an output interface between the system 900 and the user. In some embodiments, the screen may be a liquid crystal display (LCD) or a sensor panel (SP). If the screen features a sensor panel, then the screen may be implemented in the form of a touch screen for taking an input signal from the user. A sensor panel includes one or more sensor transmitters for the purposes of gestures, touching, and sliding on the sensor panel. The sensor transmitter not only can sense touch and scrolling gestures, but also determine the length of time and pressure associated with the operation mode of touching and sliding.

The input/output interface 912 provides an interface between the processing component 902 and the periphery interface module.

The sensor component 914 contains one or more sensors and is designed to feature various aspects for evaluating the system's 900 condition. For instance, the sensor component 914 may detect the condition of the on/off system 900 and the relative arrangement of components, for instance, of the display and the device 900's button panel, as well as a change in the position of the system 900 or one component of the system 900, whether there is contact between the user and the system 900, as well as the orientation or acceleration/slowing and the change in the system's 900 temperature. The sensor component 914 contains a contactless transmitter designed to detect the presence of an object located nearby when there is no physical contact. The sensor component 914 contains an optical transmitter (for instance, a CMOS or a CCD image transmitter) designed for visualizing the application. In some embodiments, the sensor component 914 contains an acceleration transmitter, a gyro sensor, a magnetic transmitter, a pressure transmitter, or a temperature transmitter.

The communication component 916 is designed for the ability to facilitate a wired or wireless connection between the system 900 and other devices. The system 900 may obtain access to a wireless network based on a connection standard, such as Wi-Fi, 2G, or 3G, or a combination of them. In one approximate variation, the 916 data transmission component obtains a broadcast signal or translation and the information associated with it from the broadcasting control system through the broadcast channel. In one embodiment, the 916 data transmission component contains a near-field communication NFC (module) in order to facilitate nearby connection. For instance, an NFC could be based on radiofrequency identification (RFID) technology, data transfer association technology in an Infrared Diapason (IrDA), ultrawideband (UWB) technology, Bluetooth (BT) technology, and other technologies.

In the example embodiment, the memory unit 904 includes the instructions that the process 918 of the implementation system 900 methods described above for measuring the distance to remote objects. For instance, an energy-independent computer readable medium may be a read only memory, a random-access memory (RAM), a compact disc, a magnetic tape, a floppy disk, optical data storage devices, and so on.

The technological result indicated above is achieved in the following way.

The technology level contains a method for determining the distance to a remote object using a controllable PTZ camera (a camera which can change the viewing direct along a vertical and horizontal line) located at a height at which the camera is pointed at an object, the distance to which is required to be determined, after which the azimuth is determined (according to the data on the viewing direction of the camera) and the location angle (according to the data on the camera's mechanism). Then, based on the information on the angle of the camera's incline, the height of the camera's installation, and the topography features, the distance that the object is located at is determined. However, in this method, an error in determining the angle of the object's location, which in this case is connected to the accuracy of the camera's positioning (which for modern modules is 0.05-0.1 degrees) and the accuracy of the camera's external calibration, constitutes the main error in determining the distance to the remote object. If there is a small amount of error in the camera's internal calibration of the location angle and a small amount of error in the camera's vertical positioning, a large amount of error will arise in determining the distance to the remote object. For instance, if one takes a camera elevation of 60 meters, a spherical land model, a total error in determining the location's angle of 0.1 degrees, the error in determining distance with an object 20 km away will be 9 km. The announced technological solution reduces error in determining the angle of the object's location and leaves an error related only to the camera's internal calibration accuracy, which can reach 0.01 degrees, a consequence of which is accuracy in determining distance with the remote object located at a distance of 20 km, which will already be less than 2 km (FIG. 10).

Shown in FIG. 10 is the achievement of the technological result; meanwhile, the error's dependence (in km) in determining the distance to the remote object is shown in the left section (in km) using the method for determining the distance from the angle of an object's location according to data from a camera's turning mechanism. Shown in the right section is the dependence of the error (in km) in determining the distance from a distance (in km) when using the method for distance determination method in the proposed way, it is noticeable that the error is significantly less in the left graphic (accuracy rises).

A specialist in this technological field can easily understand other embodiments of the invention from the examined description. This application is intended to cover any variations in which the following general invention principles may be used or applied, and including such deviations from this invention which may appear within the bounds of the known or usual practice on a technological level. It is presumed that the description is examined only as approximate, with the crux and volume of this invention, denoted with the invention's formula.

It should be kept in mind that this invention is not limited by exact constructions that weren't described above and illustrated in attached drafts and that various modifications and changes could be made without departing from its field of use. It is presumed that the invention volume is only limited by the attached formula.

### Example of Implementation

Assume that a controllable camera is situated at an elevation of 60 meters, pointed at an object; meanwhile, some amount of horizon points place it into the field of vision as well.

The azimuth is known along which the camera is pointed (the line of the camera's optical axis and the camera's orientation) as well as the internal calibration of the camera for such approximation of the camera (relationship between the pixel and the arrival angle of the optical ray). For simplicity in understanding the example, assume that the topography model is a spherical land model.

Assume that the camera has a resolution of 626×352 and its viewing angles are 4×2.25 degrees.

The camera captures a shot as shown in FIG. 3.

This shot is presented to the user and he or she uses the computer mouse to mark the object with its Xpic2 (358) Ypic2 (209) coordinates, the horizontal Xpic1 point (297), and Ypic1 (149) (as shown in FIG. 2).

Then, the azimuth is obtained in which the camera is pointed (center of the image), which is 34.5 degrees.

Then, the object's azimuth is determined based on the azimuth of the camera's direction (34.5 degrees) and the displacement of the object relative to the center. The displacement of the object relative to the center according to the horizontal line, in accordance with formulas (1) and (2) is ˜0.28 degrees

The displacement of the horizon relative to the center is, in accordance with formulas (1) and (2)˜−0.10 degrees

Then they determine that the azimuth of the object is ˜34.79 degrees.

Meanwhile, the horizon point's azimuth is ˜34.40 degrees.

Knowing the height of a tower and the model of a topography (in our case, it's a simple topography model with an Earth sphere), the location angle of the horizon point is determined along the horizon point azimuth. For an elevation of 60 meters and the spherical Earth model, it is −0.2485 degrees.

Then, the angle difference of the object location and the horizon are determined according to a simple formula as the difference between the angles along a vertical line relative

5 to the optical axis, preliminarily having determined, according to the formula (1) and (2), the vertical angles relative to the camera's optical axis. The angle difference is obtained of the location equal to 0.3835 degrees.

Then, the object's location angle is determined, counting out of the horizon location angle the angle difference of the horizon location and the object location, arriving at −0.6320 degrees.

They determine based on the data on the azimuth of the object and the topography features (the topography doesn't change based on the azimuth in the stated solution, since the model is spherical), the heights of the tower and the obtained object location angle, and the distance to the object which ends up equal to 5,6673 km. Meanwhile, for the spherical model of the Earth, simplified formulas can be used from geometry, which are obvious to a technology-level specialist.

### INFORMATION SOURCES

1. A. Samarin, Multisensory Navigation Systems for Local Positioning: Modern electronics. No. 6.-2006.-Pg. 10-17.
2. D. Forsyth, G. Ponce Computer Vision. A Modern Approach.—M. I.D.: Williams, 2004.
3. Internet Source: https://en.wikipedia.org/wiki/Camera_resectioning.
4. Internet Source: https://en.wikipedia.org/wiki/Interpolation
5. Internet source https://en.wikipedia.org/wiki/Vincenty %27s_formulae
6. Vincenty T. Direct and Inverse Solutions of Geodesics on the Ellipsoid with Application of Nested Equations//Survey Review.-1975.-T. 23.-No. 176. Pg. 88-93.

1. A method for measuring a distance to a remote object, comprising:
determination of at least one remote object point and at least one point on the horizon from an established observation height;
obtaining data on an observation azimuth of at least one point of the remote object; an observation azimuth of at least one horizon point, and data on topography features along the object's observation azimuth and along the observation azimuth of at least one horizon point;
determination of at least one angle difference of a location between at least one remote object point and at least one point on the horizon;
determination of an observation location angle of at least one point on the horizon on the basis of the data on the observation azimuth of at least one horizon point, the data on topography features, and the established observation height;
determination of an observation location angle of the remote object based on the data on the observation location angle of at least one point on the horizon; and the angle difference of the location between at least one remote object point and one point on the horizon, defined earlier;
determination of the distance to said remote object on the basis of the data on the observation location angle of the remote object; the data on the topography features; the data on the observation azimuth of the remote object, and the established observation height.

2. The method according to claim 1, wherein the data on the topography features comprise a map of the local heights.

3. The method according to claim 1, wherein a web camera is used, featuring internal and external calibration, to determine the azimuth of the object and the horizon and the angle difference of the observation location of the remote object and the horizon.

4. The method according to claim 3, wherein while the camera is in use, the object and the horizon point are located on a single image.

5. The method according to claim 3, wherein a positioned remote-controlled PTZ camera is used, which is pointed at the remote object.

6. The method according to claim 1, wherein in determining the location angle of at least one point on the horizon and determinations of the distance to an object take into account the refraction of optical rays in the atmosphere.

7. The procedure according to claim 1, wherein in obtaining the observation azimuth of the remote object, a mathematical model of a camera obscura is used.

8. The procedure according to claim 1, wherein when determining the observation location angle of the remote object, a Vincenty's formula is used.

9. A system for measuring distance to a remote object, comprising:
a video camera configured to obtain at least one shot containing the remote object and a horizon;
a processor;
a memory for storing instructions that will be executed by the processor; wherein the processor is configured to:
determine at least one remote object point and at least one point on the horizon from an established observation height;
obtain data on an observation azimuth of the remote object, data on an observation azimuth of at least one horizon point, and data on topography features along the object's observation azimuth and along the observation azimuth of at least one horizon point;
determine at least one angle difference of a location between at least one remote object point and at least one point on the horizon;
determine an observation location angle of at least one point on the horizon on the basis of the data on the observation azimuth of at least one horizon point, the data on topography features, and the established observation height;
determine an observation location angle of the remote object based on the data on the observation location angle of at least one point on the horizon; and the angle difference of the location between at least one remote object point and one point on the horizon, defined earlier;
determine the distance to said remote object on the basis of the data on the observation location angle of the remote object; the data on the topography features; the data on the observation azimuth of the remote object, and the established observation height.

10. The system according to claim 9, in which the video camera is a positioned, remote-controlled PTZ camera.

11. The system according to claim 9, in which the processor is central or graphic.

12. The system according to claim 9, in which the memory is an energy-dependent storage device or an energy-independent storage device.
